(19) United States
(12) Patent Application Publication
(10) Pub. No.: US 2008/0154606 A1
(43) Pub. Date: Jun. 26, 2008

(54) Automotive mobile electronic apparatus and operation method thereof

(76) Inventor: Michael Lee, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/806,534

(22) Filed: Jun. 1, 2007

(30) Foreign Application Priority Data
Dec. 22, 2006 (TW) 95148387

(51) Int. Cl. G10L 13/00

(52) U.S. Cl. 704/260; 704/E13.001

(57) ABSTRACT

The present invention discloses an automotive mobile electronic apparatus and its operation method installed and applied in an automobile, and a big button is operated with a voice reminder to assure the safety and efficiency of the driving. The automotive mobile electronic apparatus includes a database module, a display module, a voice broadcasting module and a processing module. The database module records the information of points of interest (POI). The display module selectively displays the information of the points of interest. The voice broadcasting module broadcasts the information of the points of interest sequentially by a text to speech (TTS). The processing module receives a control signal from a big button when the voice broadcasting module broadcasts the information of the points of interest to confirm that the broadcasting information of the points of interest is the function selected by a user.

### FIELD OF THE INVENTION

The present invention relates to an automotive mobile electronic apparatus and its operation method, and more particularly to a technical area related to the operation of an automotive mobile electronic apparatus by using a voice broadcasting and a big button.

### BACKGROUND OF THE INVENTION

In an automotive mobile electronic apparatus, a user generally needs to click on a screen of the automotive mobile electronic apparatus to open a multi-level menu interface and select a series of operations, if the user wants to use a function such as a navigation function, a song function, a photo function, a movie function or a game function while driving an automobile.

However, such doing does not comply with the requirements for safety driving, unless the user pulls over to the curb and stop the automobile before performing a long operation procedure and viewing the contents of the menu for selecting the required function. Till now, there is no automotive mobile electronic equipment or device provided for users to complete the aforementioned operation, obtain the required information, or plan a route while taking the safety of driving in consideration concurrently.

Referring to FIG. 1 for a schematic view of an example of a conventional automotive mobile electronic apparatus, the automotive mobile electronic apparatus 1 includes a main body 10 and a touch screen 11. A user can control each preinstalled function such as a navigation function, a song function, a photo function, a movie function or a game function provided by the main body 10 through the touch screen 11. However, a user generally needs to search for the items in the multi-level classified menu 111 one by one during the operation procedure, and then set the required executing function. Even though such arrangement can provide a better classified menu 111, users have to stop the automobile before viewing or clicking the touch screen 11 based on the safety consideration, and thus users can finish executing the required function such as obtaining information, planning a route or enjoying audio/video recreational programs.

As the development of science and technology mainly comes from people's insistence, many automotive mobile electronic equipment or device designers tried to provide safe controls and operations for automotive mobile electronic equipments or devices when a user is driving. At present, some of the common designs and researches provide the function of voice instruction recognition. In other words, a user can give an instruction to the automotive mobile electronic equipment or device by voice. For instance, the user can issue a voice instruction such as “Parking Lot” or “Traffic Report” to the automotive mobile electronic equipment or device, so that the automotive mobile electronic equipment or device automatically searches for the location of the nearest “parking lot” or turns on a radio for the broadcast of the “traffic report”, and provides the required information on a touch screen or executes the required function without using the conventional multi-level classified menu.

Referring to FIG. 2 for a schematic view of another example of a conventional automotive mobile electronic apparatus, the automotive mobile electronic apparatus 22 comprises a main body 10, a touch screen 11 and a voice recognition module 20. The users can use the touch screen 11 to control each preinstalled function provided by the main body 10, and also give a preinstalled voice instruction to the voice recognition module 20 for controlling each preinstalled function provided by the main body 10. However, it is questionable whether or not the voice recognition module 20 can provide a high recognition rate. Based on the consideration of safety, users have to stop driving and view the information on the touch screen 22, even after the user's required information are searched by giving the voice instruction to the recognition module 20 and displayed on the touch screen 11. Users also have to touch the position listed in the options at the points of interest carefully and accurately by a finger or a stylus in order to obtain the required information or execute the required function.

In view of the description above, finding a way to let users search for the points of interest, obtain the required information, or execute the required function while driving a motor vehicle safely is the subject of the present invention. To effectively overcome the shortcomings of the prior art, the inventor of the present invention based on years of experience on navigation devices and navigation methods to conduct extensive researches and experiments, and finally developed an automotive mobile electronic apparatus and a method of operating its function in accordance with the present invention.

### SUMMARY OF THE INVENTION

It is a primary objective of the present invention to provide an automotive mobile electronic apparatus and its operation method, and the automotive mobile electronic apparatus uses a text to speech (TTS) method to broadcast the contents of a multi-level menu sequentially and provide users a big button installed on the automotive mobile electronic apparatus, a steering wheel or a steering rod of the automobile to exempt the longer operation procedure of viewing the contents of a menu and clicking the options of the menu as required in the prior art. For instance, a user must click or touch a navigation icon on a touch screen to execute a navigation function, or a song icon to execute a song function, or a photo icon to execute a photo function, a movie icon to execute a movie function or a game icon to execute a game function. On the hand, the user can press the big button to execute a navigation function when the voice is reading the navigation function, or press the big button to execute a song function when the voice is reading the song function, or press the big button to execute a photo function when the voice is reading the photo function, or press the big button to execute a movie function when the big button is reading the movie function or press a big button to execute a game function when the voice is reading the game function.

Another objective of the present invention is to provide an automotive mobile electronic apparatus and a method of operating its functions, and the method uses a voice method to broadcast the contents of a multi-level menu sequentially and provide users a big button installed onto the automotive mobile electronic apparatus, the steering wheel or the steering rod to overcome the immature voice recognition technology and the inconvenient operating procedure of viewing the contents of a menu and clicking the options of the menu by a finger or a stylus for controlling and operating the automotive mobile electronic apparatus.

To achieve the foregoing objectives, the present invention provides a automotive mobile electronic apparatus comprising a database module, a display module, a voice broadcasting module and a processing module. The database module is a storage medium for recording the information of a plurality of points of interest according to at least one type of functions such as a navigation function, a song function, a photo function, a movie function or a game function. The voice broadcasting sequence of the information on the points of interest are arranged dynamically according to their clicking or selecting frequency. The display module is a touch screen capable of selectively displaying the information of the foregoing points of interest. Further, the voice broadcasting module uses a text to speech synthesis to broadcast the information of the foregoing points of interest. When the voice broadcasting module broadcasts the information of the points of interest at the voice module, the processing module receives a cable control signal or a wireless control signal to confirm that the broadcasted information of the points of interest are the information or function required by the users.

It is noteworthy to point out that the voice is broadcasted once for every short period of time such as one second or several seconds, so that a user can have time to respond to the broadcast and press the aforementioned big button. If the user clicks or selects an option before the next option is broadcasted, the user can select the currently broadcasting option. If the user misses the currently broadcasting option but has not touched any button yet, the broadcasting of the whole menu can be repeated. Further, an option is usually provided for users to return to the previous level of the menu.

The automotive mobile electronic apparatus further comprises a positioning receiving module for receiving a satellite signal to provide a navigation function for the foregoing points of interest. The information of the points of interest are divided into at least one type of functions such as a navigation function, a song function, a photo function, a movie function or a game function and sequentially broadcasted in voice by a voice broadcasting module. When the voice broadcasting module broadcasts a certain type of function, a user can press a big button to issue a control signal to a processing module. The processing module receives the control signal, and immediately controls the voice module to broadcast the information of each point of interest of this type. Similarly, when the voice broadcasting module continues broadcasting the information of a certain point of interest of this type, the user still can press the big button to issue a control signal to the processing module. The processing module receives the control signal and displays the information or executes the function. If the information of this point of interest still has a plurality of subtypes, then the processing module will immediately control the voice broadcasting module to broadcast the information of this point of interest information or the information of each subtype of the function, after the processing module receives the control signal.

To facilitate a user to operate the automotive electronic apparatus while driving the automobile, a big button with a large area of the press button is provided and installed on the automotive mobile electronic apparatus, a steering wheel or a steering rod of the automobile, or any other appropriate and convenient position.

Further, an operation method of the automotive mobile electronic apparatus in accordance with the present invention comprises the steps of:

(a) pressing a big button to issue a cable control signal or a wireless control signal to start a voice broadcasting function of the automotive mobile electronic apparatus;

(b) using a voice broadcasting method to sequentially broadcast a plurality of points of interest preinstalled in a database module; and

(c) pressing the big button again to issue a cable control signal or a wireless control signal while broadcasting the points of interest to confirm that the broadcasting points of interest are the information or function required by the user.

It is noteworthy to point out that the voice broadcasting is broadcasted once for every short period of time such as one second or several second to allow users to have a response time for pressing the big button. Before the information of the next point of interest shows up, a user can select the information of the broadcasting point of interest. If the user misses the information of the broadcasting point of interest and has not touched any press button yet, then the user can wait till the information of all points of interest are broadcasted and replay the broadcast. The sub-item of each point of interest or the information of each point of interest usually comes with an option for returning to the previous level of the menu.

The points of interest can be in a form of at least one type of functions such as a navigation function, a song function, a photo function, a movie function or a game function recorded in a database module. Such arrangement lets the foregoing procedure use the voice method to broadcast the types of functions sequentially. When a certain type is broadcasted, a user can press the big button installed at the automotive mobile electronic apparatus or the steering wheel or steering rod of the automobile to issue a control signal in order to confirm each point of interest in this type. Similarly, when the voice module continues broadcasting a certain point of interest of this type, the user still can press the big button to issue a control signal in order to confirm that the broadcasting point of interest is the information required by the user, or the function is executed, or if this point of interest still has sub-types, then the information of each sub-type in this point of interest will be broadcasted again, after the control signal is received. To broadcast the user's frequently used type or point of interest, the voice broadcasting sequence of the types or points of interest can be arranged according to their clicking or selecting frequency.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a schematic view of an example of a conventional automotive mobile electronic apparatus;

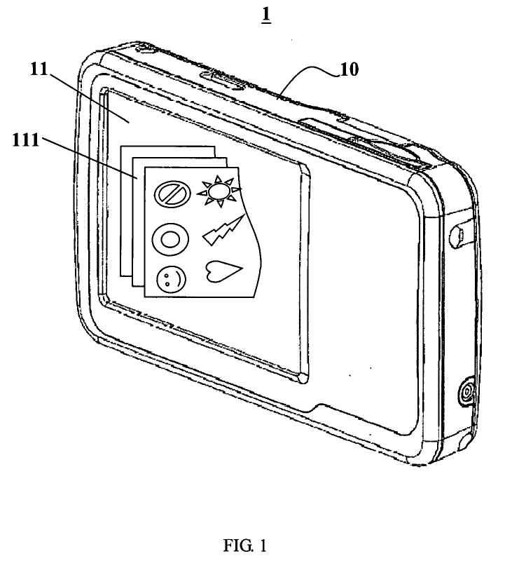

FIG. 2 is a schematic view of another example of a conventional automotive mobile electronic apparatus;

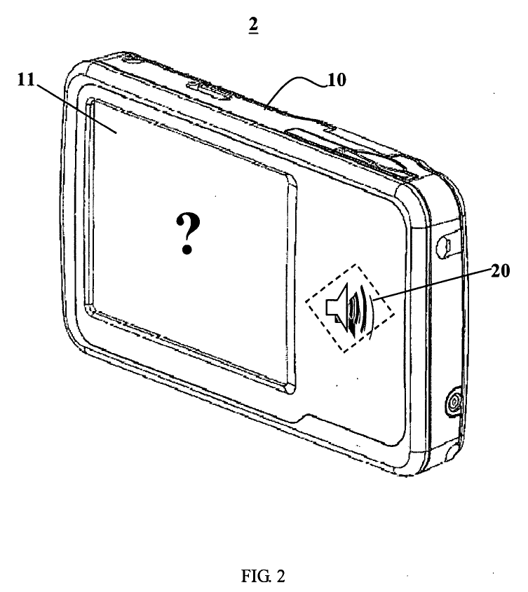

FIG. 3 is a schematic block diagram of an automotive mobile electronic apparatus of the present invention;

FIG. 4 is a schematic view of a position provided for installing a big button on an automotive mobile electronic apparatus of the present invention; and

FIG. 5 is a flow chart of an operation method of the present invention.

### DETAILED DESCRIPTION OF THE PREFERRED EMBODIMENTS

With the following related drawings, a preferred embodiment of an automotive mobile electronic apparatus and its operation method in accordance with the present invention will be described and illustrated in details. The numerals are used for representing the elements of the embodiments of the invention, and an automotive mobile electronic apparatus is adopted as a preferred embodiment of the present invention for the illustration.

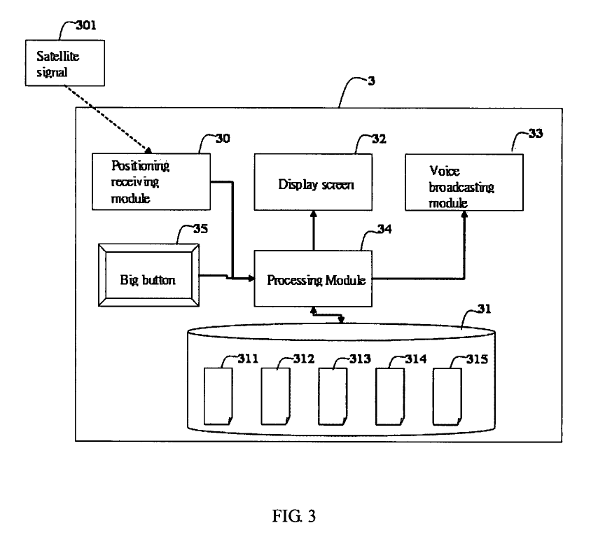

Referring to FIG. 3 for a schematic block diagram of an automotive mobile electronic apparatus of the present invention, the automotive mobile electronic apparatus 3 comprises a positioning receiving module 30, a database module 31, a display screen 32, a voice broadcasting module 33, a processing module 34 and a big button 35 having a larger area of the press button. In this embodiment, the positioning receiving module 30 is provided for receiving a satellite signal 301. The database module 31 includes the information of points of interest including a navigation function 311, a song function 312, a photo function 313, a movie function 314 and a game function 315. The display screen 32 is provided for displaying information, and the display screen 32 can be a touch display screen provided for selectively clicking and touching the information of the points of interest. The voice broadcasting module 33 uses a voice method to sequentially broadcast the information of points of interest including a navigation function 311, a song function 312, a photo function 313, a movie function 314 and a game function 315. For instance, if the voice broadcasting module 33 is broadcasting the navigation function 311, a user can touch and press the big button 35 gently while driving the automobile. By then, the voice broadcasting module 33 will interrupt the voice broadcasting of the following points of interest 312, 313, 314, 315 to enter into the navigation function 311. If the voice module 33 continues broadcasting a specific navigation location such as “Wang Steak House” in the navigation function 311, then the user can touch and press the automobile big button 35 while driving the automobile, and by then the automotive mobile electronic apparatus 3 will rearrange the route to the specified restaurant location as the new destination of the navigation. In this embodiment, the processing module 34 plays an important role of bridging the voice broadcasting module 33 and the big button 35. In other words, the processing module 14 receives a control signal 351 issued by pressing the big button 35 to conform that the voice broadcasting module 33 further broadcasts a plurality of sub-information and sub-functions of the broadcasting points of interest or confirms that the broadcasting sub-information or sub-function of the point of interest is the information or function required by the user.

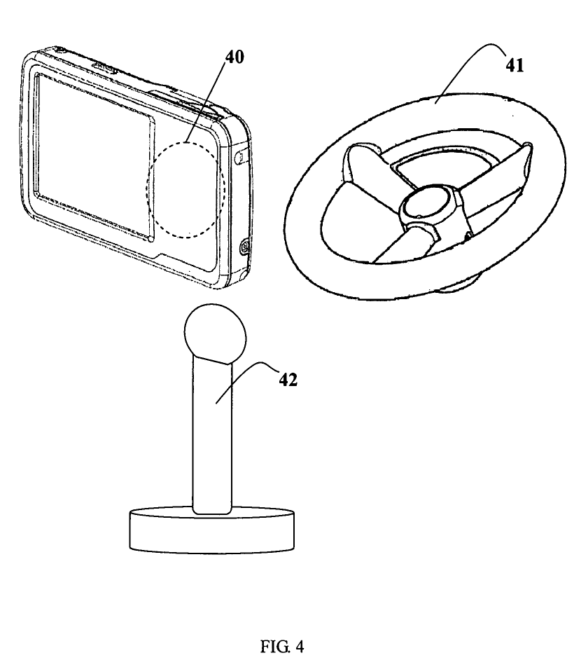

Referring to FIG. 4 for a preferred embodiment of the present invention, the area of the big button 35 is increased to facilitate users to touch and press the big button 35 gently while driving the automobile, and the big button 35 can be installed on a panel 40 of the navigation device 3 or at a steering wheel 41 or a steering rod 42 of the automobile. It is noteworthy to point out that if the big button 35 is installed on the panel 40 of the automotive mobile electronic apparatus 3, then a cable control signal will be issued. If the big button 35 is installed at the steering wheel 41 or steering rod 42 of the automobile, then a wireless control signal will be issued.

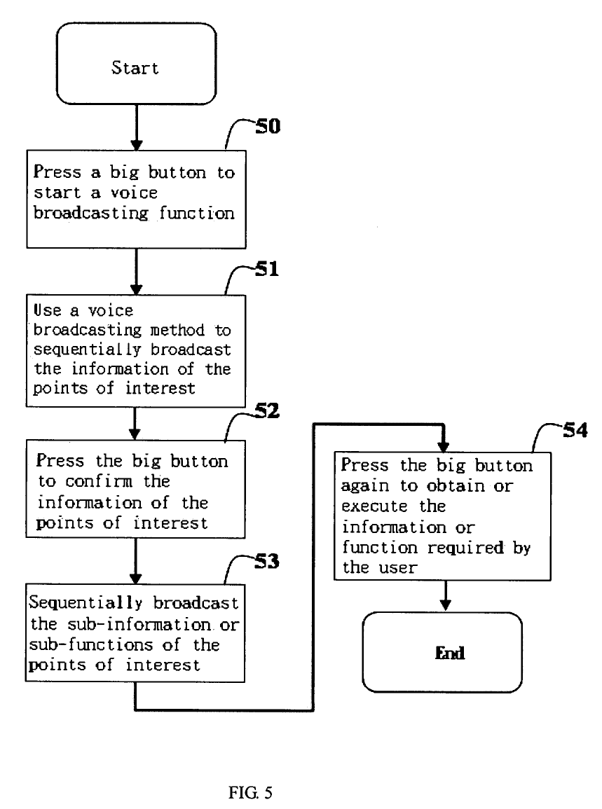

Referring to FIG. 5 for a flow chart of an operation method of an automobile mobile electronic apparatus in accordance with the present invention, the operation method comprises the steps of:

Step 50: pressing a big button to issue a cable or wireless control signal to start a voice broadcasting function of the automotive mobile electronic apparatus;

Step 51: using a voice broadcasting method to sequentially broadcast the information of the points of interest preinstalled in a database module;

Step 52: issuing a control signal by a user through the big button to confirm the broadcasting type such as the store information or audio/video recreation function when the voice method broadcasts the information of the points of interest;

Step 53: following Step 52 and using a voice method to sequentially broadcast store information or audio/video recreation functions including a plurality of store locations such as “Leadtek Store” or “Hyatt Regency Store” or a plurality of radio stations such as “BCC Radio Station” or “Police Radio Station”.

Step 54: following Step 53 and issuing a control signal from the big button by a user while a voice method broadcasts the “Hyatt Regency Store” or “BBC Radio Station”, so as to rearrange the store location “Hyatt Regency Store” as a new destination of the navigation or listen to the broadcast of the “BBC Radio Station”.

In this embodiment, the big button can be installed on a panel of an automotive mobile electronic apparatus, a steering wheel or a steering rod of an automobile. If the big button is installed on the panel of the automotive mobile electronic apparatus, then a cable control signal will be issued. If the big button is installed at the steering wheel or the steering rod of the automobile, then a wireless control signal will be issued.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automotive mobile electronic apparatus, comprising:
a database module for recording information of a plurality of points of interest;
a display module for selectively displaying the information of said plurality of points of interest;
a voice broadcasting module for broadcasting the information of said plurality of points of interest sequentially through a voice method; and
a processing module for receiving a control signal to confirm that the broadcasting information of said point of interest information is required information or function when said voice broadcasting module broadcasts the information of said plurality of points of interest.

2. The automotive mobile electronic apparatus of claim 1, further comprising a positioning receiving module for receiving a satellite signal to provide a navigation function.

3. The automotive mobile electronic apparatus of claim 1, wherein said database module records the information of said plurality of points of interest according to at least one type of information.

4. The automotive mobile electronic apparatus of claim 1, wherein said information of said point of interest comprises a navigation function, a song function, a photo function, a movie function and a game function.

5. The automotive mobile electronic apparatus of claim 4, wherein said voice broadcasting module further comprises the step of broadcasting said navigation function, said song function, said photo function, said movie function and said game function through a voice method sequentially.

6. The automotive mobile electronic apparatus of claim 1, further comprising a big button for issuing said control signal.

7. The automotive mobile electronic apparatus of claim 6, wherein said big button is installed at a steering wheel or a steering rod of an automobile.

8. The automotive mobile electronic apparatus of claim 1, wherein said control signal is a wireless signal or a cable signal.

9. An operation method for an automotive mobile electronic apparatus, and said method comprising the steps of:
pressing a big button to issue a cable or a wireless control signal and start a voice broadcasting function of said automotive mobile electronic apparatus; and
pressing said big button to issue said control signal to confirm that the broadcasting information of said point of interest information is a user's required information or a user's required function when said voice broadcasting function sequentially broadcasts the information of said plurality of points of interest preinstalled in a database module.

10. The operation method of claim 9, wherein said information of said plurality of points of interest further comprises at least one type of information recorded in said database module.

11. The operation method of claim 10, wherein said information comprises a navigation function, a song function, a photo function, a movie function and a game function.

12. The operation method of claim 10, further comprising the steps of sequentially broadcasting said navigation function, said song function, said photo function, said movie function and said game function by said voice broadcasting function.

13. The operation method of claim 9, wherein said big button is installed at said automotive mobile electronic apparatus.

14. The operation method of claim 9, wherein said big button is installed at a steering wheel or a steering rod of an automobile.

15. The operation method of claim 9, wherein said control signal is a wireless signal or a cable signal.
